(19) United States
(12) Patent Application Publication
(10) Pub. No.: US 2021/0182768 A1
(43) Pub. Date: Jun. 17, 2021

(54) WORK PLAN GENERATION APPARATUS AND WORK PLAN GENERATION METHOD

(71) Applicant: SHARP KABUSHIKI KAISHA, Sakai City (JP)

(72) Inventor: THINH NGUYENQUANG, Sakai City (JP)

(21) Appl. No.: 17/123,973

(22) Filed: Dec. 16, 2020

(30) Foreign Application Priority Data
Dec. 17, 2019 (JP) 2019-227446

(51) Int. Cl. G06Q 10/06; G06Q 10/08

(52) U.S. Cl. CPC G06Q 10/063114; G06Q 10/0835

(57) ABSTRACT

A work plan generation apparatus according to the present invention includes a worker information storage, a shipment time storage, a workload estimation information generator, a shipping preparation work time period setter, and a worker allocation plan generator. The workload estimation information generator generates workload estimation information indicating the estimated workload of a shipping preparation work for a product for each of one or more work units. The shipping preparation work time period setter sets shipping preparation work time periods corresponding to the one or more shipment times stored in the shipment time storage for each of the one or more work units. The worker allocation plan generator assigns a worker who performs the shipping preparation work to each shipping preparation work time period based on the worker information and the workload estimation information for each of the one or more work units to generate an allocation plan of the workers.

### INCORPORATION BY REFERENCE

This application is based upon and claims the benefit of priority from the corresponding Japanese Patent Application No. 2019-227446 filed on Dec. 17, 2019, the entire contents of which are incorporated herein by reference.

### BACKGROUND

The present invention relates to a work plan generation apparatus and a work plan generation method.

A computer system (work plan generation apparatus) includes a center computer. Specifically, the center computer includes an arithmetic processor and a storage. The arithmetic processor generates work sorting data. The work sorting data indicates that multiple works are performed by multiple working sections at multiple work places. The works are, for example, telephone work. The arithmetic processor corrects the previously generated work sorting data. Specifically, the arithmetic processor rewrites the expected start and/or end time of the work project in the work sorting data in a predetermined interval in accordance with the actual work progress status, the road congestion, etc.

### SUMMARY

According to an aspect of the present invention, a work plan generation apparatus includes a worker information storage, a shipment time storage, a workload estimation information generator, a shipping preparation work time period setter, and a worker allocation plan generator. The worker information storage stores worker information about multiple workers. The shipment time storage stores one or more shipment times set for each of one or more work units. The workload estimation information generator generates workload estimation information indicating an estimated workload of a shipping preparation work for a product for each of the one or more work units. The shipping preparation work time period setter sets respective shipping preparation work time periods corresponding to the one or more shipment times stored in the shipment time storage for each of the one or more work units. The worker allocation plan generator assigns a worker who performs the shipping preparation work among the workers to each of the shipping preparation work time periods based on the worker information and the workload estimation information for each of the one or more work units to generate an allocation plan of the workers.

According to another aspect of the present invention, a work plan generation method includes first storing, second storing, generating, setting, and assigning. At the first storing, worker information about multiple workers is stored. At the second storing, one or more shipment times set for each of one or more work units are stored. At the generating, workload estimation information indicating an estimated workload of a shipping preparation work for a product is generated for each of the one or more work units. At the setting, respective shipping preparation work time periods corresponding to the one or more shipment times stored at the second storing are set for each of the one or more work units. At the assigning, a worker who performs the shipping preparation work among the workers is assigned to each of the shipping preparation work time periods based on the worker information and the workload estimation information for each of the one or more work units to generate an allocation plan of the workers.

### BRIEF DESCRIPTION OF THE DRAWINGS

FIG. 1 is a diagram illustrating the inside of a distribution warehouse in which a work plan generation apparatus is installed according to an embodiment of the present invention;

FIG. 2 is a block diagram illustrating the work plan generation apparatus according to the present embodiment;

FIG. 3 is a table illustrating order information according to the present embodiment;

FIG. 4 is a table illustrating worker information according to the present embodiment;

FIG. 5 is a table illustrating a shipment time according to the present embodiment;

FIG. 6 is a table illustrating an allocation plan according to the present embodiment;

FIG. 7 is a table illustrating an allocation plan according to the present embodiment; and

FIG. 8 is a flowchart illustrating an example of a process of a controller according to the present embodiment.

### DETAILED DESCRIPTION

An embodiment of the present invention is described with reference to the drawings. In the drawings, the identical or corresponding components are denoted by the same reference numeral and the description thereof is not repeated.

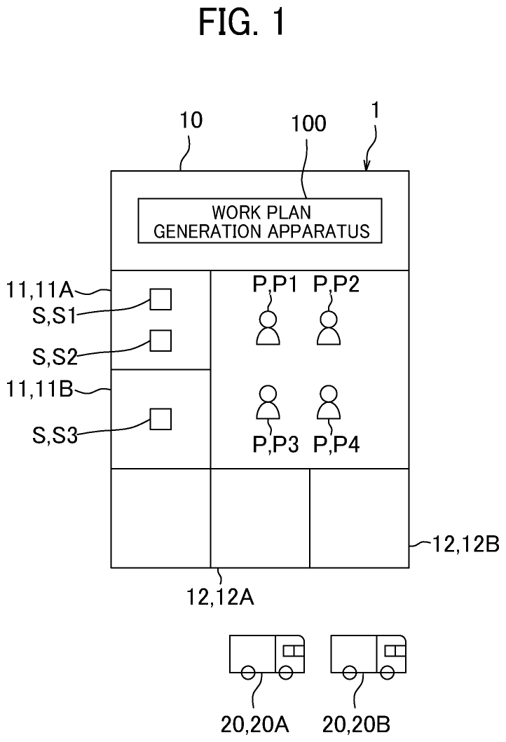

A distribution warehouse 1 according to the present embodiment is described with reference to FIG. 1. FIG. 1 is a diagram illustrating the inside of the distribution warehouse 1 in which a work plan generation apparatus 100 is installed. As illustrated in FIG. 1, the distribution warehouse 1 includes a plurality of storages 11, a plurality of workspaces 12, and an office 10. The distribution warehouse 1 is located in a first place. The first place is, for example, a distribution warehouse in “Osaka”. The work plan generation apparatus 100 is provided in the office 10.

In the distribution warehouse 1, multiple workers P perform shipping preparation works. The workers P include, for example, a worker P1, a worker P2, a worker P3, a worker P4, and a worker P5. The worker P5 is not illustrated as the worker P5 is not in the distribution warehouse 1. In the drawings, the identification information on the worker P1 is denoted by “P1”, the identification information on the worker P2 by “P2”, the identification information on the worker P3 by “P3”, the identification information on the worker P4 by “P4”, and the identification information on the worker P5 by “P5”.

Multiple products S are stored in each of the storages 11. The storages 11 include, for example, a first storage 11A and a second storage 11B. Each of a first product S1, a second product S2, and a third product S3 is, for example, one part of a finished product. The products S include, for example, the first product S1, the second product S2, and the third product S3. Specifically, a large number of the first products S1 and a large number of the second products S2, for example, are stored in the first storage 11A. For example, a large number of the third products S3 are stored in the second storage 11B.

In each of the storages 11, the workers P perform a shipping preparation work. Specifically, the shipping preparation work includes a collection work or a packing work. Specifically, a collection work for collecting a predetermined number of the first products S1 or a predetermined number of the second products S2 or a packing work for packing a predetermined number of the first products S1 or a predetermined number of the second products S2 is performed in the first storage 11A. A collection work for collecting a predetermined number of the third products S3 or a packing work for packing a predetermined number of the third products S3 is performed in the second storage 11B.

Multiple trucks 20 leave for the respective destinations from the workspaces 12. The workspaces 12 include, for example, a first workspace 12A and a second workspace 12B. The trucks 20 include, for example, a first truck 20A and a second truck 20B. The destinations include, for example, a second place and a third place. The second place is, for example, an assembly factory in “Kyoto”. The third place is a place farther from the first place as compared with the second place and is, for example, an assembly factory in “Tokyo”. Specifically, the first truck 20A leaves for the assembly factory in “Kyoto” from the first workspace 12A. The second truck 20B leaves for the assembly factory in “Tokyo” from the second workspace 12B.

In each of the workspaces 12, the workers P perform a shipping preparation work. Specifically, the shipping preparation work includes a loading work. Specifically, in the first workspace 12A, a loading work is performed to load a predetermined number of the first products S1, a predetermined number of the second products S2, or a predetermined number of the third products S3 into the truck 20A. In the second workspace 12B, a loading work is performed to load a predetermined number of the first products S1, a predetermined number of the second products S2, or a predetermined number of the third products S3 into the second truck 20B.

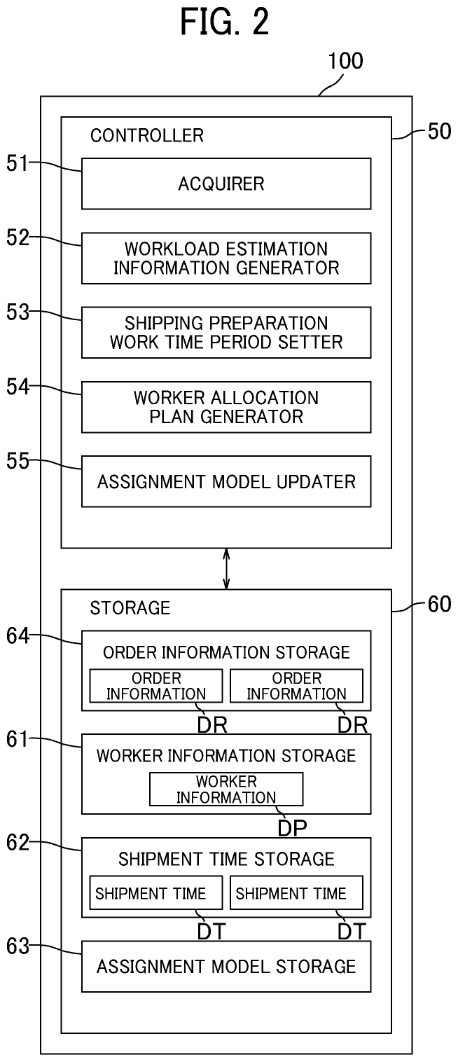

The work plan generation apparatus 100 is described with reference to FIG. 2. FIG. 2 is a block diagram illustrating the work plan generation apparatus 100. As illustrated in FIG. 2, the work plan generation apparatus 100 includes a controller 50 and a storage 60.

The storage 60 includes a worker information storage 61, a shipment time storage 62, an assignment model storage 63, and an order information storage 64. Specifically, the storage 60 includes a storage device, a semiconductor memory, and a database for information processing. The storage device is, for example, a hard disk drive (HDD) and/or a solid state drive (SSD). The semiconductor memory is, for example, a random access memory (RAM) and a read only memory (ROM). The database is, for example, Oracle (registered trademark) Database, MySQL (registered trademark), SQLite, or Microsoft (registered trademark) SQL Server.

The worker information storage 61 stores worker information DP. The worker information DP relates to the workers P. The shipment time storage 62 stores one or more shipment times DT.

The controller 50 includes an acquirer S1. Specifically, the controller 50 includes a processor such as a central processing unit (CPU). The controller 50 executes a control program stored in the storage 60.

The acquirer 51 acquires a plurality of sets of order information DR via a network such as a local area network (LAN). Specifically, the acquirer 51 acquires a plurality of sets of the order information DR for 24 hours. The order information storage 64 stores the sets of the order information DR.

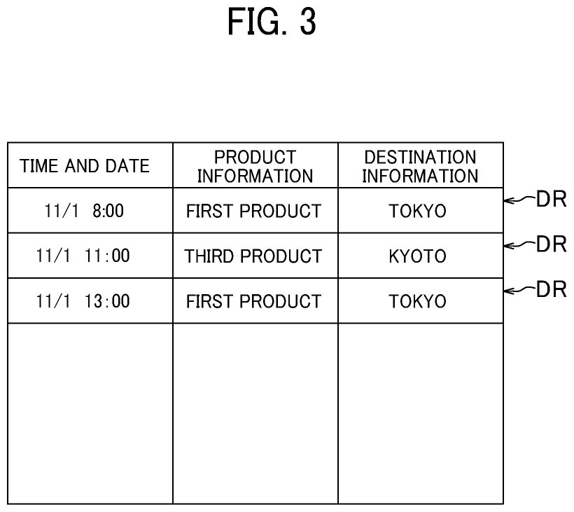

Next, the order information DR is described with reference to FIGS. 1 to 3. FIG. 3 is a table illustrating the order information DR. As illustrated in FIG. 3, for example, time and date, product information, and destination information are related to each other in the order information DR. The destination information indicates a destination. The product information indicates the type and the number of the products S. That is, the order information DR indicates that a predetermined type and a predetermined number of the products S are to be transported to the destination. Accordingly, a “work unit” for transporting a predetermined type and a predetermined number of the products S to the destination is set. The “work unit” may be set by using a working group, a working section, or a working area to which the worker P performing a shipping preparation work in the distribution warehouse 1 for shipping the product S is assigned.

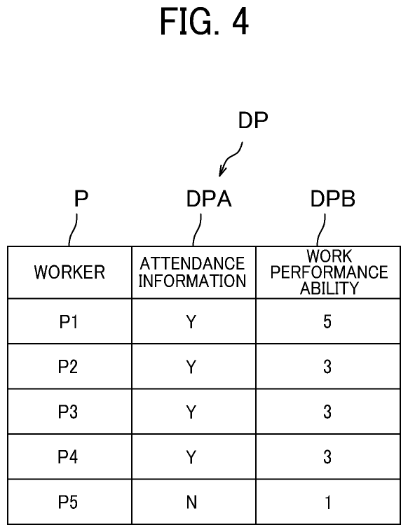

Next, the details of the worker information DP are described with reference to FIGS. 1 to 4. FIG. 4 is a table illustrating the worker information DP. As illustrated in FIG. 4, for example, the worker P, attendance information DPA, and information DPB about the work performance ability are related to each other in the worker information DP. The attendance information DPA indicates whether each of the workers P is attending work. Specifically, when the worker P1 is attending work, the attendance information DPA indicates “Y”. When the worker P5 is not attending work, the attendance information DPA indicates “N”.

The information DPB about the work performance ability includes the information about the work performance ability of each of the workers P. Specifically, the information DPB about the work performance ability is the skill information indicating the working speed. The work performance ability is represented by using the index for the shipping preparation work of the product S performed by each of the workers P. Specifically, the work performance ability is indicated in five levels. Specifically, the work performance ability indicates one numerical value selected from “1” to “5”. For example, the work performance ability of the worker P1 is “5”, which is a fast working speed. On the other hand, the work performance ability of the worker P5 is “1”, which is a slow working speed.

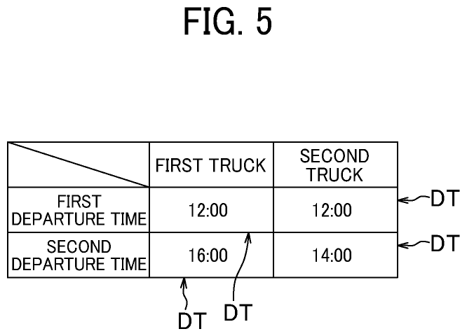

Subsequently, the details of the shipment time DT are described with reference to FIGS. 1 to 5. FIG. 5 is a table illustrating the shipment time DT. As illustrated in FIG. 5, it is indicated that a first departure time of the first truck 20A is “12:00” and a second departure time is “16:00”. In other words, it is indicated that the shipment times DT for “Kyoto” are “12:00” and “16:00”. The shipment time DT is set for each work unit for transporting a predetermined type and a predetermined number of the products S to the destination. Therefore, the shipment time DT “12:00” or “16:00” is set for the work unit for transporting the product S to “Kyoto”. Further, it is indicated that a first departure time of the second truck 20B is “12:00” and a second departure time is “14:00”. In other words, it is indicated that the shipment times DT for “Tokyo” are “12:00” and “14:00”. Therefore, the shipment time DT “12:00” or “14:00” is set for the work unit for transporting the product S to “Tokyo”.

As illustrated in FIG. 2, the controller 50 includes a workload estimation information generator 52, a shipping preparation work time period setter 53, a worker allocation plan generator 54, and an assignment model updater 55 in addition to the acquirer 51.

The workload estimation information generator 52 generates workload estimation information. The workload estimation information indicates the estimated workload of a shipping preparation work for the product S for each of one or more work units. Specifically, the estimated workload is represented by using a numerical value. For example, when the workload estimation information generator 52 assigns the estimated workload to the work unit for transporting a predetermined number of the first products S1 and a predetermined number of the second products S2 to “Kyoto”, the workload estimation information generator 52 assigns the estimated workload “80”, which is a large number, as the number of the products S is large. When the estimated workload is assigned to the work unit for transporting a predetermined number of the third products S3 to “Tokyo”, the estimated workload “40”, which is a small number, is assigned as the number of the products S is small.

The shipping preparation work time period setter 53 sets the shipping preparation work time period for each of one or more work units. The shipping preparation work time period corresponds to each of the one or more shipment times DT stored in the shipment time storage 62. For example, the shipping preparation work time period setter 53 sets, as the shipping preparation work time period, the time period from 30 minutes before the shipment time until the shipment time.

The worker allocation plan generator 54 generates an allocation plan DA based on the worker information DP and the workload estimation information. Specifically, the worker allocation plan generator 54 assigns at least one of the workers P to each of one or more work units to generate the allocation plan DA for the workers P. The worker P performs a shipping preparation work in each of the shipping preparation work time periods set for the work unit.

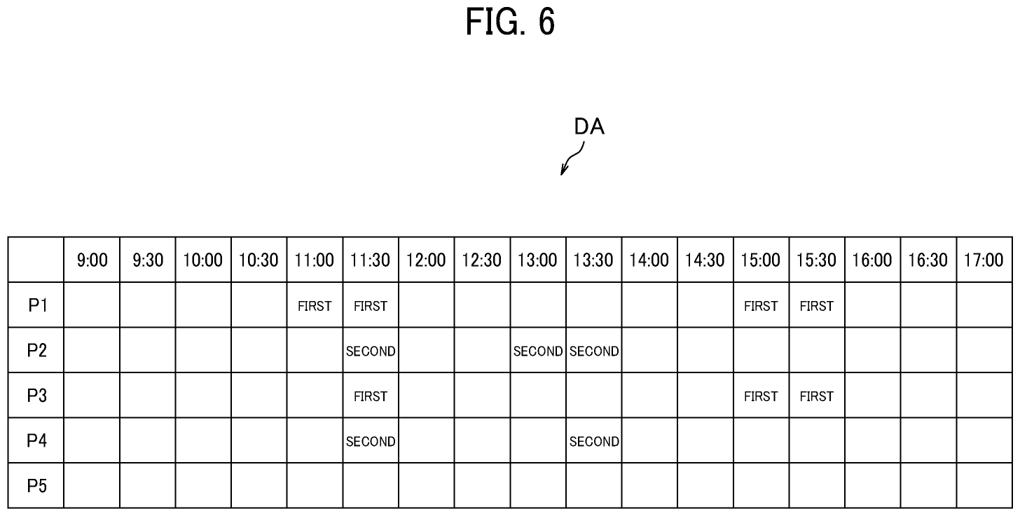

The allocation plan DA is described with reference to FIG. 6. FIG. 6 is a table illustrating the allocation plan DA. As illustrated in FIG. 6, for example, the worker P, the time, and the work unit are related to each other in the allocation plan DA. For example, the time is indicated in an interval of 30 minutes from 9:00 to 17:00. As for the work unit, the shipping preparation work for a loading work at the first workspace 12A is denoted by “first”. The shipping preparation work for a loading work at the second workspace 12B is denoted by “second”.

For example, the worker P1 with a working speed of “5” performs a loading work from 11:00 to 12:00 at the first workspace 12A, in which the estimated workload is large. The worker P3 with a working speed of “3” performs a loading work from 11:30 to 12:00 at the first workspace 12A. The worker P2 with a working speed of “3” performs a loading work from 11:30 to 12:00 at the second workspace 12B, in which the estimated workload is small. The worker P4 with a working speed of “3” performs a loading work from 11:30 to 12:00 at the second workspace 12B.

As described above, the worker allocation plan generator 54 generates the allocation plan DA based on the worker information DP and the workload estimation information. Accordingly, the workers P perform a shipping preparation work in each of the shipping preparation work time periods. The shipping preparation work time period corresponds to each of the one or more shipment times DT. Therefore, the shipping preparation work may be completed by the shipment time DT. The worker information DP includes the attendance information DPA. Thus, the worker allocation plan generator 54 may generate the worker information DP to generate the more appropriate allocation plan DA. The worker information DP includes the information DPB about the work performance ability. Thus, the worker allocation plan generator 54 may use the worker information DP to generate the more appropriate allocation plan DA.

Specifically, the worker allocation plan generator 54 assigns the shipping preparation workload to each of the shipping preparation work time periods. The shipping preparation workload indicates the workload of a predetermined shipping preparation work that is included in the estimated workload and that needs to be completed by the shipment time. For example, the worker allocation plan generator 54 assigns the worker P who performs a shipping preparation work to each of the shipping preparation work time periods such that the shipping preparation work of the assigned shipping preparation workload is completed. Therefore, the workers P may be assigned in accordance with a shipping preparation workload. As a result, it is possible to further ensure that the shipping preparation work is completed by the shipment time DT.

More specifically, the workload estimation information generator 52 predicts the shipping preparation workload that is expected to be added during the period from a first time to a second time. The first time is set based on a first shipment time. The second time is set based on a second shipment time. The second shipment time is a shipment time subsequent to the first shipment time.

Specifically, the first time is a time previous to the first shipment time by a first predetermined time. Particularly, the first predetermined time is one hour. The second time is a time previous to the second shipment time by a second predetermined time. Particularly, the second predetermined time is 30 minutes. The second predetermined time is a time with which shipping preparation work may be performed by the second time.

For example, the workload estimation information generator 52 predicts the shipping preparation workload based on the order information DR one year earlier or the previous day. The workload estimation information generator 52 assumes that the order information DR that is identical to the order information DR acquired during the period between the first time and the second time on the previous day is also acquired on the current day. For example, the workload estimation information generator 52 assumes that the order information DR identical to the order information DR for transporting the product S to “Kyoto”, which is acquired during the period from 11:00 to 15:30 on the previous day, is acquired. As a result, the workload estimation information generator 52 calculates the shipping preparation workload based on the order information DR.

The worker allocation plan generator 54 assigns the shipping preparation workload to the shipping preparation work time period corresponding to the second shipment time. For example, the worker allocation plan generator 54 assigns the shipping preparation workload based on the order information DR for transporting the product S to “Kyoto”, acquired by 11:00 on the current day, to the shipping preparation work time period corresponding to the first shipment time. Further, the worker allocation plan generator 54 assigns the shipping preparation workload that is expected to be acquired during the period from 11:00 to 15:30 on the current day to the shipping preparation work time period corresponding to the second shipment time.

As described above, the workload estimation information generator 52 predicts the shipping preparation workload that is expected to be added during the period from the first time to the second time. The worker allocation plan generator 54 assigns the shipping preparation workload to the shipping preparation work time period corresponding to the second shipment time. Thus, the shipping preparation work may be performed for the order information DR acquired by the second time on the current day. As a result, it is possible to respond on the current day. The first time is a time previous to the first shipment time by the first predetermined time, and the second time is a time previous to the second shipment time by the second predetermined time. Therefore, the shipping preparation work may be performed in the second predetermined time based on the order information DR acquired by the second time on the current day. As a result, it is possible to respond on the current day with more certainty.

The worker allocation plan generator 54 acquires actual performance data. The actual performance data includes, for example, the information indicating whether the shipping preparation work of the estimated workload has been completed after the performance of the actual shipping preparation work. When the shipping preparation work has not been completed, the worker allocation plan generator 54 regenerates an allocation plan DB based on the worker information DP and the workload estimation information. For example, when the actual performance data, indicating that the shipping preparation work for transporting the third product S3 to “Tokyo” has not been completed, is acquired, the worker allocation plan generator 54 changes the allocation plan DA into the allocation plan DB in real time.

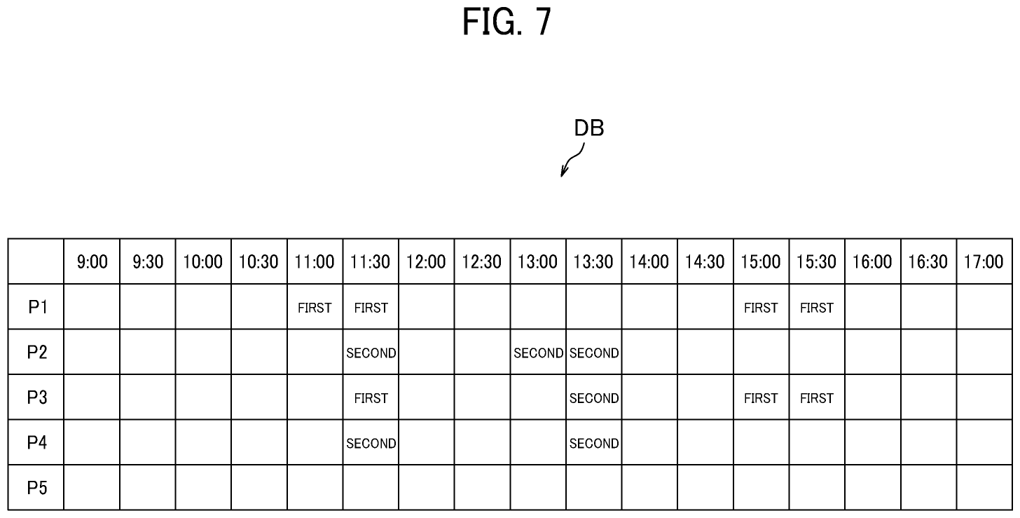

The allocation plan DB is described with reference to FIGS. 6 and 7. FIG. 7 is a table illustrating the allocation plan DB. As illustrated in FIG. 7, for example, the worker P, the time, and the work unit are related to each other in the allocation plan DB.

In the allocation plan DA illustrated in FIG. 6, the worker P3 performs a loading work at the first workspace 12A from 11:30 to 12:00 and performs a loading work at the first workspace 12A from 15:30 to 16:00. In the allocation plan DB illustrated in FIG. 7, the worker P3 performs a loading work at the first workspace 12A from 11:30 to 12:00, performs a loading work at the second workspace 12B from 13:30 to 14:00, and performs a loading work at the first workspace 12A from 15:30 to 16:00. That is, as the shipping preparation work of the estimated workload has not been completed in the allocation plan DA illustrated in FIG. 6, the loading work performed by the worker P3 at the second workspace 12B from 13:30 to 14:00 is added to the allocation plan DB illustrated in FIG. 7. Thus, it is possible to respond to a change in the shipping preparation work at the workspace 12. For example, the number of the workers P required may be temporarily increased during the shipping preparation work time period immediately before the shipment time. As a result, it is possible to further ensure that the shipping preparation work is completed by the shipment time DT.

More specifically, the assignment model storage 63 stores the assignment model of the worker P. The assignment model includes the information indicating the worker P assigned to each shipping preparation work time period corresponding to the worker information DP and the workload estimation information for each of one or more work units.

Specifically, the assignment model includes the template indicating the number of the workers P assigned to each of the time periods. For example, the assignment model includes the information in which the single worker P is assigned to the shipping preparation work time period from 11:00 to 11:30 corresponding to the work unit for transporting the first product S1 and the second product S2 to “Kyoto” and the two workers P are assigned to the shipping preparation work time period from 11:30 to 12:00.

The worker allocation plan generator 54 executes assignment of the workers P based on the assignment model. Therefore, the worker allocation plan generator 54 may accurately generate the allocation plan DA.

The assignment model updater 55 updates the assignment model based on the actual performance data in the past. Therefore, the worker allocation plan generator 54 may accurately generate the allocation plan DA. For example, the assignment model updater 55 updates the assignment model in a case where the shipping preparation work is completed up to 15 minutes before. Specifically, the assignment model includes information such that the assignment of the two workers P to a shipping preparation work time period is changed to the assignment of the single worker P to the shipping preparation work time period. Thus, it is possible to suppress the shortage or excess of the work processing capability of the workspace 12.

The assignment model updater 55 may update the work performance ability of the worker P stored in the worker information storage 61. For example, the assignment model updater 55 updates the work performance ability of the worker P5 from “3” to “4”.

When there are multiple work units, the worker allocation plan generator 54 assigns the worker P selected from the workers P to a specific work unit that is given priority among the work units based on a predetermined condition. Thus, the high-priority shipping preparation work may be completed. The predetermined condition is preferably that the work unit having the earlier final shipment time is given priority among the work units. According to this preferable example, an urgent shipping preparation work may be completed. As a result, it is possible to further ensure that the shipping preparation work is completed by the shipment time DT.

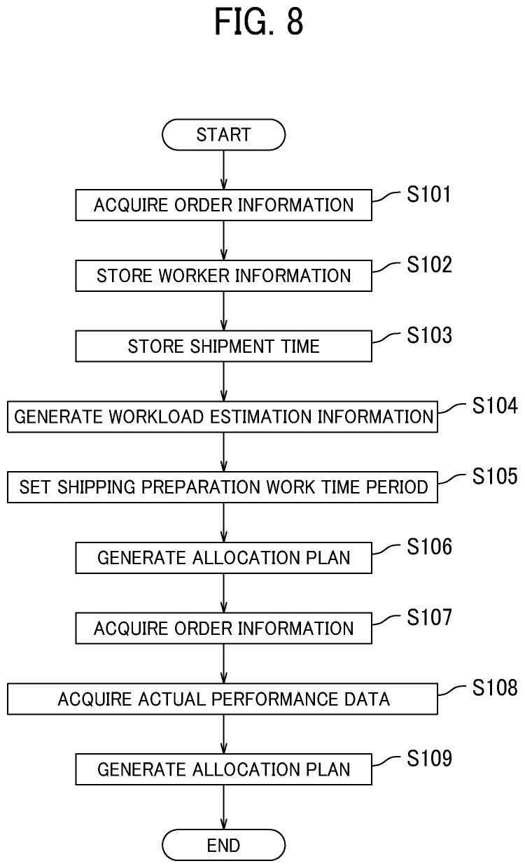

Next, a process of the controller 50 is described with reference to FIG. 8. FIG. 8 is a flowchart illustrating an example of the process of the controller 50.

As illustrated in FIG. 8, first, at Step S101, the acquirer 51 sequentially acquires the plurality of sets of the order information DR.

Subsequently, at Step S102, the worker information storage 61 stores the worker information DP about the workers P.

Then, at Step S103, the shipment time storage 62 stores the one or more shipment times DT.

Then, at Step S104, the workload estimation information generator 52 generates workload estimation information.

Then, at Step S105, the shipping preparation work time period setter 53 sets a shipping preparation work time period for each of the one or more work units.

Then, at Step S106, the worker allocation plan generator 54 assigns the worker P to each of the one or more work units based on the worker information DP and the workload estimation information to generate the allocation plan DA.

Then, at Step S107, the acquirer 51 sequentially acquires the plurality sets of the order information DR.

Then, at Step S108, the assignment model updater 55 acquires the actual performance data.

Then, at Step S109, the worker allocation plan generator 54 assigns the worker P to each of the one or more work units based on the worker information DP and the workload estimation information to generate the allocation plan DB. Afterward, the process ends.

The embodiment of the present invention has been described above with reference to the drawings. The present invention is not limited to the above-described embodiment and may be implemented in various aspects without departing from the scope thereof. In the drawings, the components are primarily illustrated in a schematic manner for easy understanding, and the thickness, length, number, etc. of the components illustrated differ from the reality for the sake of creation of the drawings. The material, shape, dimension, etc. of the components illustrated in the above embodiment are merely examples and are not particularly limited and may be variously modified without substantially departing from the advantages of the present invention.

(1) Although the worker allocation plan generator 54 generates the allocation plan DA based on the worker information DP and the workload estimation information in the work plan generation apparatus 100 described with reference to FIGS. 1 to 8, the worker allocation plan generator 54 may generate the allocation plan DA and the allocation plan DB through machine learning.

(2) Although the second departure time is the final shipment time in the work plan generation apparatus 100 described with reference to FIGS. 1 to 8, the present invention is not limited thereto. For example, a third departure time may be further provided so that the third departure time is the final shipment time.

### INDUSTRIAL APPLICABILITY

The present invention may be used in the field of work plan generation apparatuses.

What is claimed is:

1. A work plan generation apparatus comprising:
a worker information storage that stores worker information about multiple workers;
a shipment time storage that stores one or more shipment times set for each of one or more work units;
a workload estimation information generator that generates workload estimation information indicating an estimated workload of a shipping preparation work for a product for each of the one or more work units;
a shipping preparation work time period setter that sets respective shipping preparation work time periods corresponding to the one or more shipment times stored in the shipment time storage for each of the one or more work units; and
a worker allocation plan generator that assigns a worker who performs the shipping preparation work among the workers to each of the shipping preparation work time periods based on the worker information and the workload estimation information for each of the one or more work units to generate an allocation plan of the workers.

2. The worker plan generation apparatus according to claim 1, wherein the worker allocation plan generator
assigns a shipping preparation workload to each of the shipping preparation work time periods based on the worker information and the workload estimation information, and
assigns the worker who performs the shipping preparation work to each of the shipping preparation work time periods such that the shipping preparation work of the assigned shipping preparation workload is completed.

3. The work plan generation apparatus according to claim 2, wherein the worker allocation plan generator assigns the shipping preparation workload that is predicted by the workload estimation information generator to be added during a period from a first time, set based on a first shipment time, to a second time, set based on a second shipment time which is a shipment time subsequent to the first shipment time, to the shipping preparation work time period corresponding to the second shipment time.

4. The work plan generation apparatus according to claim 3, wherein
the first time is a time previous to the first shipment time by a first predetermined time, and
the second time is a time previous to the second shipment time by a second predetermined time.

5. The work plan generation apparatus according to claim 1, wherein the worker information includes attendance information indicating whether each of the workers is attending work.

6. The work plan generation apparatus according to claim 1, wherein
the worker information includes information about a work performance ability of each of the workers, and
the work performance ability is represented by using an index for the shipping preparation work of the product performed by each of the workers.

7. The work plan generation apparatus according to claim 1, further comprising an assignment model storage that stores an assignment model of the worker, wherein
the assignment model includes information indicating the worker assigned to each of the shipping preparation work time periods corresponding to the worker information and the workload estimation information for each of the one or more work units, and
the worker allocation plan generator assigns the workers based on the assignment model.

8. The work plan generation apparatus according to claim 7, further comprising an assignment model updater that updates the assignment model based on actual performance data in past.

9. The work plan generation apparatus according to claim 1, wherein when there are the work units, the worker allocation plan generator assigns a worker selected from the workers to a specific work unit that is given priority among the work units based on a predetermined condition.

10. The work plan generation apparatus according to claim 9, wherein the predetermined condition is that the work unit having an earlier final shipment time is given priority among the work units.

11. A work plan generation method comprising:
first storing worker information about multiple workers;
second storing one or more shipment times set for each of one or more work units;
generating workload estimation information indicating an estimated workload of a shipping preparation work for a product for each of the one or more work units;
setting respective shipping preparation work time periods corresponding to the one or more shipment times stored at the second storing for each of the one or more work units; and
assigning a worker who performs the shipping preparation work among the workers to each of the shipping preparation work time periods based on the worker information and the workload estimation information for each of the one or more work units to generate an allocation plan of the workers.
